(19) United States
(12) Patent Application Publication
(10) Pub. No.: US 2026/0148365 A1
(43) Pub. Date: May 28, 2026

(54) ENCODING DESIGN INFORMATION FOR A SPECIMEN FOR RUNTIME USE IN INSPECTION AND OTHER PROCESSES

(71) Applicant: KLA Corporation, Milpitas, CA (US)

(72) Inventors: Gordon Rouse, Dublin, CA (US); Anil Kumar Pulugurtha, Fremont, CA (US); Benjamin Moyer, Santa Clara, CA (US)

(21) Appl. No.: 18/959,278

(22) Filed: Nov. 25, 2024

(51) Int. Cl. G06T 7/00; G06T 7/70; G06T 9/00

(52) U.S. Cl. CPC G06T 7/0006; G06T 7/70; G06T 9/00; G06T 2207/20081; G06T 2207/30148

(57) ABSTRACT

Methods and systems for determining information for a specimen are provided. One system includes a deep learning (DL) model configured for transforming information for a design for a specimen into an encoded representation of the design that includes encoded design attributes as a function of position in the design. A computer system stores the encoded representation for use in a process performed on the specimen by a tool. The encoded representation may be configured as a design attribute map that can be used for applications such as, but not limited to, defect classification and nuisance filtering. One significant advantage of the embodiments described herein is that they enable such applications to be performed inline even for substantially large numbers of defects.

### BACKGROUND OF THE INVENTION

### 1. Field of the Invention

The present invention generally relates to methods and systems for determining information for a specimen. Certain embodiments relate to deep learning (DL) transformations of a specimen design into an encoded representation that includes encoded design attributes as a function of position in the design for use in processes such as defect classification and nuisance filtering.

### 2. Description of the Related Art

The following description and examples are not admitted to be prior art by virtue of their inclusion in this section.

Fabricating semiconductor devices such as logic and memory devices typically includes processing a substrate such as a semiconductor wafer using a large number of semiconductor fabrication processes to form various features and multiple levels of the semiconductor devices. For example, lithography is a semiconductor fabrication process that involves transferring a pattern from a reticle to a resist arranged on a semiconductor wafer. Additional examples of semiconductor fabrication processes include, but are not limited to, chemical-mechanical polishing (CMP), etch, deposition, and ion implantation. Multiple semiconductor devices may be fabricated in an arrangement on a single semiconductor wafer and then separated into individual semiconductor devices.

Inspection processes are used at various steps during a semiconductor manufacturing process to detect defects on specimens to drive higher yield in the manufacturing process and thus higher profits. Inspection has always been an important part of fabricating semiconductor devices. However, as the dimensions of semiconductor devices decrease, inspection becomes even more important to the successful manufacture of acceptable semiconductor devices because smaller defects can cause the devices to fail.

Defect review typically involves re-detecting defects detected as such by an inspection process and generating additional information about the defects at a higher resolution using either a high magnification optical system or a scanning electron microscope (SEM). Defect review is therefore performed at discrete locations on specimens where defects have been detected by inspection. The higher resolution data for the defects generated by defect review is more suitable for determining attributes of the defects such as profile, roughness, more accurate size information, etc. Defects can generally be more accurately classified into defect types based on information determined by defect review compared to inspection.

Metrology processes are also used at various steps during a semiconductor manufacturing process to monitor and control the process. Metrology processes are different than inspection processes in that, unlike inspection processes in which defects are detected on a specimen, metrology processes are used to measure one or more characteristics of the specimen that cannot be determined using currently used inspection tools. For example, metrology processes are used to measure one or more characteristics of a specimen such as a dimension (e.g., line width, thickness, etc.) of features formed on the specimen during a process such that the performance of the process can be determined from the one or more characteristics. In addition, if the one or more characteristics of the specimen are unacceptable (e.g., out of a predetermined range for the characteristic(s)), the measurements of the one or more characteristics of the specimen may be used to alter one or more parameters of the process such that additional specimens manufactured by the process have acceptable characteristic(s).

Metrology processes are also different than defect review processes in that, unlike defect review processes in which defects that are detected by inspection are re-visited in defect review, metrology processes may be performed at locations at which no defect has been detected. In other words, unlike defect review, the locations at which a metrology process is performed on a specimen may be independent of the results of an inspection process performed on the specimen. In particular, the locations at which a metrology process is performed may be selected independently of inspection results. In addition, since locations on the specimen at which metrology is performed may be selected independently of inspection results, unlike defect review in which the locations on the specimen at which defect review is to be performed cannot be determined until the inspection results for the specimen are generated and available for use, the locations at which the metrology process is performed may be determined before an inspection process has been performed on the specimen.

The most important information that is generated by the processes described above is usually information related to if the devices are being and/or can be formed on or with the specimens as intended. In other words, the primary purpose of inspection is to find defects on the specimen so that how they will impact the devices being formed on the specimen can be determined. In another example, the primary purpose of metrology is determining if the device structures are being formed on the specimen with the intended characteristics such as dimensions, roughness, flatness, shape, location, etc.

A major area of exploration in the last several decades has, therefore, been how to use information about the devices being formed on or with the specimen in such processes to thereby determine device-relevant information. While many yield-related processes and systems have been developed to utilize information for device design, there are often significant obstacles in creating such processes and systems that are practical and cost effective.

To illustrate such obstacles with just one use case example, some existing methods that utilize IC physical design information for nuisance defect filtering and defect of interest (DOI) classification require design clip extraction for each defect detected during inspection. Design clip extraction for each and every defect and utilizing such design clips for nuisance filtering and DOI classification is, in theory, relatively straightforward. However, some inspection tools available on the market today can detect up to one million candidate defects per second, each of which have to be input to nuisance filtering and defect classification. Obviously, therefore, design clip extraction for every detected defect is substantially expensive computationally. In other words, it is substantially expensive to perform design clip extraction for every detected candidate defect on tools that detect such substantially large numbers of defects. Even some relatively straightforward methods of utilizing design information to enhance yield-related processes, therefore, may be impractical and not used at all due to just the costs involved in carrying out those methods.

Accordingly, it would be advantageous to develop systems and methods for determining information for a specimen that do not have one or more of the disadvantages described above.

### SUMMARY OF THE INVENTION

The following description of various embodiments is not to be construed in any way as limiting the subject matter of the appended claims.

One embodiment relates to a system configured for determining information for a specimen. The system includes a computer system and one or more components executed by the computer system. The one or more components include a deep learning (DL) model configured for transforming information for a design for a specimen input to the DL model by the computer system into an encoded representation of the design that includes encoded design attributes as a function of position in the design. The computer system is configured for storing the encoded representation for use in a process performed on the specimen by a tool. The system may be further configured as described herein.

Another embodiment relates to a computer-implemented method for determining information for a specimen. The method includes transforming information for a design for a specimen into an encoded representation of the design that includes encoded design attributes as a function of position in the design. The transforming is performed by a DL model included in one or more components executed by the computer system. The steps of the method may be further performed as described herein. The method may include any other step(s) of any other method(s) described herein. The method may be performed by any of the systems described herein.

An additional embodiment relates to a non-transitory computer-readable medium storing program instructions executable on a computer system for performing a computer-implemented method for determining information for a specimen. The computer-implemented method includes the steps of the method described above. The computer-readable medium may be further configured as described herein. The steps of the computer-implemented method may be performed as described further herein. In addition, the computer-implemented method for which the program instructions are executable may include any other step(s) of any other method(s) described herein.

A further embodiment relates to a system configured for determining information for a specimen that includes a computer system configured for identifying positions in an encoded representation of a design for a specimen corresponding to positions on the specimen at which output is generated by a tool during a process performed on the specimen by the tool. The encoded representation is generated by a DL model configured for transforming information for the design for the specimen into the encoded representation, and the encoded representation includes encoded design attributes as a function of position in the design. The computer system is also configured for decoding the encoded design attributes at the identified positions and determining information for the specimen based on the decoded design attributes. The system may be further configured as described herein.

### BRIEF DESCRIPTION OF THE DRAWINGS

Further advantages of the present invention will become apparent to those skilled in the art with the benefit of the following detailed description of the preferred embodiments and upon reference to the accompanying drawings in which:

FIGS. 1 and 2 are schematic diagrams illustrating side views of embodiments of a system configured as described herein;

FIG. 3 is a flow chart illustrating an embodiment of a training phase for a deep learning (DL) model configured as described herein for transforming information for a design into an encoded representation of the design;

FIG. 4 is a schematic diagram illustrating a plan view of an embodiment of an encoded representation of a design that may be generated by the embodiments described herein and a flow chart illustrating an embodiment of a runtime phase for determining information for a specimen with the encoded representation; and

FIG. 5 is a block diagram illustrating one embodiment of a non-transitory computer-readable medium storing program instructions for causing a computer system to perform a computer-implemented method described herein.

While the invention is susceptible to various modifications and alternative forms, specific embodiments thereof are shown by way of example in the drawings and are herein described in detail. The drawings may not be to scale. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENTS

The terms “design,” “design data,” and “design information” as used interchangeably herein generally refer to the physical design (layout) of an IC or other semiconductor device and data derived from the physical design through complex simulation or simple geometric and Boolean operations. The design may include any other design data or design data proxies described in commonly owned U.S. Pat. No. 7,570,796 issued on Aug. 4, 2009 to Zafar et al. and U.S. Pat. No. 7,676,077 issued on Mar. 9, 2010 to Kulkarni et al., both of which are incorporated by reference as if fully set forth herein. In addition, the design data can be standard cell library data, integrated layout data, design data for one or more layers, derivatives of the design data, and full or partial chip design data. Furthermore, the “design,” “design data,” and “design information” described herein refers to information and data that is generated by semiconductor device designers in a design process and is therefore available for use in the embodiments described herein well in advance of printing of the design on any physical specimens such as reticles and wafers.

The term “defects of interest (DOIs)” as used herein is defined as defects that are detected on a specimen and are really actual defects on the specimen. Therefore, the DOIs are of interest to a user because users generally care about how many and what kind of actual defects are on specimens being inspected. In some contexts, the term “DOI” is used to refer to a subset of all of the actual defects on the specimen, which includes only the actual defects that a user cares about. For example, there may be multiple types of DOIs on any given specimen, and one or more of them may be of greater interest to a user than one or more other types. Unless otherwise noted herein, the term “DOIs” is used to refer to any and all real defects on a specimen.

“Nuisances” (which is sometimes used interchangeably with “nuisance defects”) as that term is used herein is generally defined as defects that a user does not care about and/or events that are detected on a specimen but are not really actual defects on the specimen. Nuisances that are not actually defects may be detected as events due to non-defect noise sources on a specimen (e.g., grain in metal lines on the specimen, signals from underlaying layers or materials on the specimen, line edge roughness (LER), relatively small critical dimension (CD) variation in patterned attributes, thickness variations, etc.) and/or due to marginalities in the inspection system itself or its configuration used for inspection.

The term “detected defect” as used herein is defined as a defect that is detected on a specimen, but has not necessarily been confirmed as an actual defect instead of nuisance or noise. Therefore, a “detected defect” may also be commonly referred to in the art as a “detected event,” a “candidate defect,” and a “potential defect.” In addition, the term “detected defect” as used herein refers to not just defects detected in the materials or structures on the specimen, e.g., due to a marginality in the fabrication process and/or the specimen, but also any fall-on particles, residual material, etc., that may be detected as defects even if they are not defects within the specimen itself.

Detected defects may then be identified as actual defects, or not nuisance or noise, in a few different ways. The most common step, and sometimes the first of multiple steps, performed for detected defects is nuisance filtering to separate the nuisance and the noise from actual defects. Nuisance filtering can be considered a kind of defect classification, but in the most simple sense, meaning that it only separates real detected defects from nuisances and noise. Defect classification on the other hand, as that term is used in the art, may include some nuisance filtering, but often is more involved. For example, defect classification generally involves separating detected defects into different classes, kinds, types, etc. of defects. So, detected defects may be classified as nuisance type defects, but also different types of real defects. One or more of those real defect types may also be DOIs, i.e., different types of DOIs. The classes may each be associated with some ID, and may also be referred to as bins or groups. The defects may be separated into different types based on one or more attributes, such as those described further herein, that are different for different types of defects.

Turning now to the drawings, it is noted that the figures are not drawn to scale. In particular, the scale of some of the elements of the figures is greatly exaggerated to emphasize characteristics of the elements. It is also noted that the figures are not drawn to the same scale. Elements shown in more than one figure that may be similarly configured have been indicated using the same reference numerals. Unless otherwise noted herein, any of the elements described and shown may include any suitable commercially available elements.

One embodiment relates to a system configured for determining information for a specimen. As described further herein, the information determined for the specimen by the system may include an encoded representation of the specimen design that is then stored for use in a process performed on the specimen and/or other specimens having the same design. The information determined for the specimen may also or alternatively be information determined for the specimen using the encoded representation performed by a tool such as an inspection tool, a defect review tool, or another yield-related tool. For example, as described further herein, the system may be configured to use the encoded representation for nuisance filtering, defect classification, defect sampling, etc.

In some embodiments, the specimen is a wafer. The wafer may include any wafer known in the semiconductor arts. Although some embodiments may be described herein with respect to a wafer or wafers, the embodiments are not limited in the specimens for which they can be used. For example, the embodiments described herein may be used for specimens such as reticles, flat panels, personal computer (PC) boards, and other semiconductor specimens.

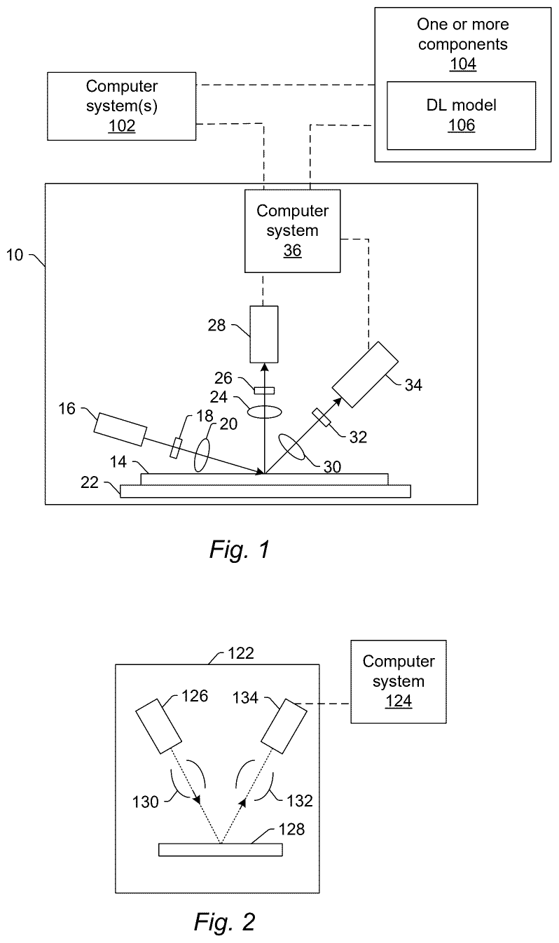

One embodiment of such a system is shown in FIG. 1. The system includes a computer system, e.g., one or more computer systems 102. In some embodiments, the system includes tool 10, which may be configured as one of the types of tools described herein such as an inspection, metrology, or defect review tool. The tool may include an imaging and/or measurement subsystem and computer system 36.

In general, the imaging and/or measurement subsystems (also referred to herein simply and collectively as the “imaging subsystem”) of the tools described herein include at least an energy source and a detector. The energy source is configured to generate energy that is directed to a specimen. The detector is configured to detect energy from the specimen and to generate output responsive to the detected energy.

In a light-based tool, the energy directed to the specimen includes light, and the energy detected from the specimen includes light. For example, as shown in FIG. 1, the imaging subsystem includes an illumination subsystem configured to direct light to specimen 14. The illumination subsystem includes at least one light source, e.g., light source 16. The illumination subsystem is configured to direct the light to the specimen at one or more angles of incidence, which may include one or more oblique angles and/or one or more normal angles. For example, as shown in FIG. 1, light from light source 16 is directed through optical element 18 and then lens 20 to specimen 14 at an oblique angle of incidence. The oblique angle of incidence may include any suitable oblique angle of incidence, which may vary depending on, for instance, characteristics of the specimen and the defects to be detected on the specimen, the characteristics of the specimen to be measured, etc.

The illumination subsystem may be configured to direct the light to the specimen at different angles of incidence. For example, the imaging subsystem may be configured to alter one or more parameters of one or more elements of the illumination subsystem such that the light can be directed to the specimen at an angle of incidence that is different than that shown in FIG. 1. In one such example, the imaging subsystem may be configured to move light source 16, optical element 18, and lens 20 such that the light is directed to the specimen at a different oblique angle of incidence or a normal (or near normal) angle of incidence. The illumination subsystem may have any other suitable configuration known in the art for directing the light to the specimen at one or more angles of incidence sequentially or simultaneously.

The illumination subsystem may also be configured to direct light with different characteristics to the specimen. For example, optical element 18 may be configured as a spectral filter and the properties of the spectral filter can be changed in a variety of different ways (e.g., by swapping out one spectral filter with another) such that different wavelengths of light can be directed to the specimen at different times.

Light source 16 may include a broadband plasma (BBP) light source. In this manner, the light generated by the light source and directed to the specimen may include broadband light. However, the light source may include any other suitable light source such as any suitable laser known in the art configured to generate light at any suitable wavelength(s). In addition, the laser may be configured to generate light that is monochromatic or nearly-monochromatic. In this manner, the laser may be a narrowband laser. The light source may also include a polychromatic light source that generates light at multiple discrete wavelengths or wavebands.

Light from optical element 18 may be focused onto specimen 14 by lens 20. Although lens 20 is shown in FIG. 1 as a single refractive optical element, in practice, lens 20 may include a number of refractive and/or reflective optical elements that in combination focus the light from the optical element to the specimen. The illumination subsystem shown in FIG. 1 and described herein may include any other suitable optical elements (not shown). Examples of such optical elements include, but are not limited to, polarizing component(s), spectral filter(s), spatial filter(s), reflective optical element(s), apodizer(s), beam splitter(s), aperture(s), and the like, which may include any such suitable optical elements known in the art. In addition, the system may be configured to alter one or more elements of the illumination subsystem based on the type of illumination to be used for imaging.

The imaging subsystem may also include a scanning subsystem configured to change the position on the specimen to which the light is directed and from which the light is detected and possibly to cause the light to be scanned over the specimen. For example, the imaging subsystem may include stage 22 on which specimen 14 is disposed during imaging. The scanning subsystem may include any suitable mechanical and/or robotic assembly (that includes stage 22) that can be configured to move the specimen such that the light can be directed to and detected from different positions on the specimen. In addition, or alternatively, the imaging subsystem may be configured such that one or more optical elements of the imaging subsystem perform some scanning of the light over the specimen such that the light can be directed to and detected from different positions on the specimen. The light may be scanned over the specimen in any suitable fashion such as in a serpentine-like path or in a spiral path.

The imaging subsystem includes one or more detection channels. At least one of the detection channel(s) includes a detector configured to detect light from the specimen due to illumination of the specimen by the tool and to generate output responsive to the detected light. The imaging subsystem shown in FIG. 1 includes two detection channels, one formed by collector 24, element 26, and detector 28 and another formed by collector 30, element 32, and detector 34. The two detection channels are configured to collect and detect light at different angles of collection. In some instances, both detection channels are configured to detect scattered light, and the detection channels are configured to detect light that is scattered at different angles from the specimen. However, one or more of the detection channels may be configured to detect another type of light from the specimen (e.g., reflected light).

In FIG. 1, both detection channels are shown positioned in the plane of the paper and the illumination subsystem is also shown positioned in the plane of the paper. Therefore, in this embodiment, both detection channels are positioned in (e.g., centered in) the plane of incidence. However, one or more of the detection channels may be positioned out of the plane of incidence. For example, the detection channel formed by collector 30, element 32, and detector 34 may be configured to collect and detect light that is scattered out of the plane of incidence. Therefore, such a detection channel may be commonly referred to as a “side” channel, and such a side channel may be centered in a plane that is substantially perpendicular to the plane of incidence.

Although FIG. 1 shows an embodiment of the imaging subsystem that includes two detection channels, the imaging subsystem may include a different number of detection channels (e.g., only one detection channel or two or more detection channels). The detection channel formed by collector 30, element 32, and detector 34 may form one side channel as described above, and the imaging subsystem may include an additional detection channel (not shown) formed as another side channel that is positioned on the opposite side of the plane of incidence. Therefore, the imaging subsystem may include the detection channel that includes collector 24, element 26, and detector 28 and that is centered in the plane of incidence and configured to collect and detect light at scattering angle(s) that are at or close to normal to the specimen surface. This detection channel may therefore be commonly referred to as a “top” channel, and the imaging subsystem may also include two or more side channels configured as described above. As such, the imaging subsystem may include at least three channels (i.e., one top channel and two side channels), and each of the at least three channels is configured to collect light at different scattering angles than each of the other collectors.

As described further above, one or more of the detection channels may be configured to detect scattered light. Therefore, the imaging subsystem shown in FIG. 1 may be configured for dark field (DF) imaging. However, the imaging subsystem may also or alternatively include detection channel(s) that are configured for bright field (BF) imaging. Therefore, the imaging subsystems described herein may be configured for only DF, only BF, or both DF and BF imaging. Although each of the collectors are shown in FIG. 1 as single refractive optical elements, each of the collectors may include refractive optical element(s) and/or reflective optical element(s).

The one or more detection channels may include any suitable detectors known in the art such as photo-multiplier tubes (PMTs), charge coupled devices (CCDs), and time delay integration (TDI) cameras. The detectors may also include non-imaging detectors or imaging detectors. If the detectors are non-imaging detectors, each of the detectors may be configured to detect certain characteristics of the light such as intensity but may not be configured to detect such characteristics as a function of position within the imaging plane. As such, the output that is generated by each of the detectors in each of the detection channels may be signals or data, but not image signals or image data. In such instances, a computer system may be configured to generate images of the specimen from the non-imaging output of the detectors. However, in other instances, the detectors may be configured as imaging detectors that are configured to generate imaging signals or image data. Therefore, the imaging subsystem may be configured to generate images in a number of ways.

Computer system 36 may be coupled to the detectors of the imaging subsystem in any suitable manner (e.g., via one or more transmission media, which may include “wired” and/or “wireless” transmission media) such that the computer system can receive the output generated by the detectors. Computer system 36 may be configured to perform a number of functions using the output of the detectors as described further herein. Computer system 36 may be further configured as described herein.

Computer system 36 (as well as other computer systems described herein) may also be referred to herein as computer subsystem(s). Each of the computer subsystem(s) or system(s) described herein may take various forms, including a personal computer system, image computer, mainframe computer system, workstation, network appliance, Internet appliance, or other device. In general, the term “computer system” may be broadly defined to encompass any device having one or more processors, which executes instructions from a memory medium. The computer subsystem(s) or system(s) may also include any suitable processor known in the art such as a parallel processor. In addition, the computer subsystem(s) or system(s) may include a computer platform with high speed processing and software, either as a standalone or a networked tool.

If the system includes more than one computer system, then the different computer systems may be coupled to each other such that images, data, information, instructions, etc. can be sent between the computer systems. For example, computer system 36 may be coupled to computer system(s) 102 as shown by the dashed line in FIG. 1 by any suitable transmission media, which may include any suitable wired and/or wireless transmission media known in the art. Two or more of such computer systems may also be effectively coupled by a shared computer-readable storage medium (not shown).

In an electron beam-based tool, the energy directed to the specimen includes electrons, and the energy detected from the specimen includes electrons. In one such embodiment shown in FIG. 2, the imaging subsystem includes electron column 122, and the system includes computer system 124 coupled to the imaging subsystem. Computer system 124 may be configured as described above. In addition, such an imaging subsystem may be coupled to another one or more computer systems in the same manner described above and shown in FIG. 1.

As also shown in FIG. 2, the electron column includes electron beam source 126 configured to generate electrons that are focused to specimen 128 by one or more elements 130. The electron beam source may include, for example, a cathode source or emitter tip, and one or more elements 130 may include, for example, a gun lens, an anode, a beam limiting aperture, a gate valve, a beam current selection aperture, an objective lens, and a scanning subsystem, all of which may include any such suitable elements known in the art.

Electrons returned from the specimen (e.g., secondary electrons) may be focused by one or more elements 132 to detector 134. One or more elements 132 may include, for example, a scanning subsystem, which may be the same scanning subsystem included in element(s) 130.

The electron column may include any other suitable elements known in the art. In addition, the electron column may be further configured as described in U.S. Pat. No. 8,664,594 issued Apr. 4, 2014 to Jiang et al., U.S. Pat. No. 8,692,204 issued Apr. 8, 2014 to Kojima et al., U.S. Pat. No. 8,698,093 issued Apr. 15, 2014 to Gubbens et al., and U.S. Pat. No. 8,716,662 issued May 6, 2014 to MacDonald et al., which are incorporated by reference as if fully set forth herein.

Although the electron column is shown in FIG. 2 as being configured such that the electrons are directed to the specimen at an oblique angle of incidence and are scattered from the specimen at another oblique angle, the electron beam may be directed to and scattered from the specimen at any suitable angles. In addition, the electron beam imaging subsystem may be configured to use multiple modes to generate output for the specimen as described further herein (e.g., with different illumination angles, collection angles, etc.). The multiple modes of the electron beam imaging subsystem may be different in any output generation parameters of the imaging subsystem.

Computer system 124 may be coupled to detector 134 as described above. The detector may detect electrons returned from the surface of the specimen thereby forming electron beam images of (or other output for) the specimen. The electron beam images may include any suitable electron beam images. Computer system 124 may be configured to perform any step(s) described herein. A tool or system that includes the imaging subsystem shown in FIG. 2 may be further configured as described herein.

FIGS. 1 and 2 generally illustrate configurations of an imaging subsystem of a tool that may be included in the system embodiments described herein. Obviously, the imaging subsystem configurations described herein may be altered to optimize the performance of the imaging subsystem as is normally performed when designing a commercial imaging system. In addition, the systems described herein may be implemented using an existing imaging subsystem or tool (e.g., by adding functionality described herein to an existing inspection tool) such as the tools that are commercially available from KLA Corp., Milpitas, Calif. For some such systems, the methods described herein may be provided as optional functionality of the tool (e.g., in addition to other functionality of the tool). Alternatively, the tools described herein may be designed “from scratch” to provide a completely new system.

Although the tool is described above as being a light or electron beam tool, the tool may be an ion beam tool. Such a tool may be configured as shown in FIG. 2 except that the electron beam source may be replaced with any suitable ion beam source known in the art. In addition, the tool may include any other suitable ion beam system such as those included in commercially available focused ion beam (FIB) systems, helium ion microscopy (HIM) systems, and secondary ion mass spectroscopy (SIMS) systems.

The imaging subsystem may be configured to generate output, e.g., images, of the specimen with multiple modes. In general, a “mode” is defined by the values of parameters of the imaging subsystem used for generating images of a specimen (or the output used to generate images of the specimen). Therefore, modes may be different in the values for at least one of the parameters of the imaging subsystem (other than position on the specimen at which the output is generated). For example, the modes may be different in any one or more alterable parameters (e.g., illumination polarization(s), angle(s), wavelength(s), etc., detection polarization(s), angle(s), wavelength(s), etc.) of the imaging subsystem. The imaging subsystem may be configured to scan the specimen with the different modes in the same scan or different scans, e.g., depending on the capability of using multiple modes to scan the specimen at the same time.

In a similar manner, the electron beam subsystem may be configured to generate images with two or more modes, which can be defined by the values of parameters of the electron beam subsystem used for generating images for a specimen. Therefore, modes may be different in the values for at least one of the electron beam parameters of the electron beam subsystem. For example, different modes may use different angles of incidence for illumination.

The tools described herein may be configured as an inspection tool, a metrology tool, and/or a defect review tool. For example, the embodiments of the tools shown in FIGS. 1 and 2 may be modified in one or more parameters to provide different capability depending on the application for which they will be used. In one such example, the imaging subsystem may be configured to have a higher resolution if it is to be used for metrology rather than for inspection. In other words, the embodiments of the tool shown in FIGS. 1 and 2 describe some general and various configurations for an imaging subsystem that can be tailored in a number of manners that will be obvious to one skilled in the art to produce tools having different imaging capabilities that are more or less suitable for different applications.

In this manner, the imaging subsystem may be configured for generating output that is suitable for detecting or re-detecting defects on the specimen in the case of an inspection tool or a defect review tool, respectively, and for measuring one or more characteristics of the specimen in the case of a metrology tool. In an inspection tool, computer system 36 shown in FIG. 1 may be configured for detecting defects on specimen 14 by applying a defect detection method or algorithm to output generated by one or more of the detectors. In a defect review tool, computer system 124 shown in FIG. 2 may be configured for re-detecting defects on specimen 128 by applying a defect re-detection method to the output generated by detector 134 and possibly determining additional information for the re-detected defects using the output generated by the detector. In a metrology tool, computer system 36 shown in FIG. 1 may be configured for determining one or more characteristics of specimen 14 using the output generated by detectors 28 and/or 34. The system that includes such tools may be further configured for detecting or re-detecting defects on the specimen, determining characteristics of the specimen, determining other information for the specimen, etc. as described further herein.

As noted above, the imaging subsystem is configured for scanning energy (e.g., light, electrons, etc.) over a physical version of the specimen thereby generating output for the physical version of the specimen. In this manner, the imaging subsystem may be configured as an “actual” subsystem, rather than a “virtual” subsystem. However, a storage medium (not shown) and computer system(s) 102 shown in FIG. 1 may be configured as a “virtual” system. In particular, the storage medium and the computer system(s) may be configured as a “virtual” imaging system as described in commonly assigned U.S. Pat. No. 8,126,255 issued on Feb. 28, 2012 to Bhaskar et al. and U.S. Pat. No. 9,222,895 issued on Dec. 29, 2015 to Duffy et al., which are incorporated by reference as if fully set forth herein. The embodiments described herein may be further configured as described in these patents.

The system includes a computer system, which may include any of the computer systems described further herein, e.g., computer system 36 and/or computer system(s) 102 shown in FIG. 1, and one or more components 104 executed by the computer system. The one or more components include a deep learning (DL) model 106 configured for transforming information for a design for a specimen input to the DL model by the computer system into an encoded representation of the design that includes encoded design attributes as a function of position in the design. The computer system may be configured for inputting the design for the specimen into the DL model in any suitable manner known in the art.

In one embodiment, the encoded representation is configured as a design attribute map (DAM) that includes the encoded design attributes as the function of the position in the design. In this manner, the embodiments may be configured for generating a DAM for uses described herein such as defect classification and nuisance filtering. Encoding of design-based (classification and other) information in a map specifically for nuisance defect filtering and defect classification (and possibly other uses) is an important new feature of the embodiments described herein. The design information in the DAM is optimized with supervised machine learning (ML) technologies, trained on labeled data. In other words, the supervised ML technology optimizes the design based attributes in the encoded representation.

FIG. 4 illustrates how a DAM may be configured in possibly the most general sense. As shown in FIG. 4, DAM 402 may include encoded design attributes (EDA) as a function of position in X and Y (in design coordinate space). Therefore, each of the squares in DAM 402 may correspond to a pixel in the DAM (or a raster image configured as described herein). Although relatively few EDAs are shown in FIG. 4, in practice, the DAM may include EDAs for as many positions in the design as desired or practical (e.g., hundreds, thousands, tens of thousands, or even a million or more positions). In addition, although the DAM may include only one EDA for every design position in X and Y, the DAM may include more than one EDA for every design position in X and Y. For example, the DAM may include EDA 1, 2, and 3 for every design position (in other words, the same 3 types of EDAs, each of whose actual value for each design position will vary depending on the design).

In some instances, the DAM may be combined with or integrated into a different map used for a process described herein. For example, the design-based attribute (DBA) information may be included in an existing segmentation map for the specimen, where segmentation means that different specimen output generated by the tool is processed differently based on its characteristics. For example, a segmentation map may include a segmentation ID for each segmentation map pixel, which may be determined based on, for example, design information corresponding to each pixel. The pixels in a specimen image may then be segmented by identifying the pixels in the segmentation map that correspond to the specimen image pixels and assigning the specimen image pixels to their respective segments. Different segments may then be processed separately and differently, e.g., with different defect detection thresholds in the case of defect detection. In some cases, a segmentation map may include a number of bits used for segmentation, and an additional number of bits may be added to the map for information for the encoded representation. Of course, this is only one example of a map into which the encoded representation information may be integrated or combined. The encoded representation map may have any suitable form or format whether it is combined with other information or not.

In another embodiment, the encoded representation is configured as a raster image for at least a portion of an entire device in the design, and each pixel in the raster image includes the encoded design attributes at the position in the design corresponding to each pixel. For example, design data starts out in vector format, and the computer system or another system or method may convert the design data to a raster image for convolution or DL network processing performed as described herein. In this manner, the DAM for functions described herein like defect classification may be a raster image of the entire device, and each pixel may include compressed/encoded design information optimized for design-based defect classification and/or other functions described herein. Each pixel in the raster image may include two or more encoded design attributes, i.e., encoded design attributes 1 and 2 at pixel 0, encoded design attributes 1 and 2 at pixel 1, and so on. In this manner, each pixel in the raster image may include different values of one or more encoded design attributes.

Although the embodiments described herein may be configured for raster image inputs and outputs for the DL model, the embodiments are not limited in this manner. For example, instead of a raster image, the embodiments may use a different image representation such as a vector image in which shapes are defined as mathematical formulas, not a pixel grid. Other types of non-image formats may also be possible for the inputs and outputs of the DL model.

The DL model does not perform forward simulation or rule-based approaches and, as such, a model of the physical (or other) relationship between the design for the specimen and any attributes of interest for the design (for which an encoded representation is being generated) is not necessary. Instead, as described further herein, the DL model can be learned (in that its parameters can be learned) based on a suitable training set of data. As described further herein, such DL models have a number of advantages for the embodiments described herein.

The DL model may be configured to have a DL architecture in that the DL model may include multiple layers, which perform a number of algorithms or transformations. The number of layers included in the DL model may be use case dependent. The layers included in the DL model may be configured as described further herein. In one such example, the DL model may be configured to compute a DAM pixel by convolving the design context of the pixel with one or more convolution filters, and encoding the output of those convolutions in a single pixel (presumably with reduced resolution). In another such example, the DL model may include a DL classifier configured to generate design attributes for a given location and encode the DL classifier outputs (e.g., DOI probability) in the DAM pixel.

In another non-limiting example, the DL model may be configured for deriving a set of Gabor convolutions to compute design attributes. A Gabor filter is a bandpass filter allowing frequencies with a certain band while attenuating other frequencies outside that band. In general, one or more layers of the design for the specimen may be selected based on, for example, information for the optical properties of the material stack present on the specimen. In this manner, the design for the specimen that is input to the DL model may include the design for more than one layer on the specimen. If the design for more than one layer is input to the DL model, the layers may include an uppermost layer on the specimen and one or more underlying layers on the specimen. The process performed for the specimen with the encoded representation may include determining information for only the uppermost layer of the specimen or the uppermost layer and one or more of the underlying layer(s).

Once the layer(s) are selected, design polygons as a function of position in the design, per selected layer, may be extracted in vector format. The design polygons may be rasterized to produce a grayscale image, one image per layer. The pixel size used for rasterization may be at least twice as small as the smallest feature in the design to avoid aliasing and distortions. The result of this step may be a set of grayscale images per design position. Power spectral density (PSD) plots may then be generated, and PSD peaks may be identified for each layer. Gabor filters may be derived from these PSD peaks and used to compute design attributes, which are subsequently used to distinguish DOI from nuisance.

In another non-limiting example, the DL model may utilize a DL network (e.g., ResNet) to predict, for example, the DOI probability of a design context. Residual neural networks (ResNets) may be generally defined in the art as a network where there are shortcuts between some layers that jump over layers in between. The networks may also have any suitable configuration known in the art including plain networks (ones that don't include shortcuts) and various types of networks that include shortcuts (e.g., Highway Nets and DenseNets). Examples of some such suitable network configurations are described in “Densely Connected Convolutional Networks,” by Huang et al., arXiv: 1608.06993, Jan. 28, 2018, 9 pages and “Deep Residual Learning for Image Recognition,” by He et al., arXiv: 1512.03385, Dec. 10, 2015, 12 pages, which are incorporated by reference as if fully set forth herein.

Although the “DAM generator” will most likely be a DL network of some kind because of the benefits of such a configuration, the DAM generator may also be a different kind of attribute generator. In other words, the concepts described herein may be performed with a different type of architecture, function, algorithm, etc. that can be configured to generate an encoded representation of a specimen design as described herein if so desired.

In some embodiments, the DL model is configured for learning how to perform the transforming by supervised learning. For example, the DL model may be trained by supervised learning. In general, supervised learning or training involves using labeled training data for training a DL model. Supervised learning or training is therefore different from unsupervised training since the training data used in those cases is unlabeled. In one such example, the DL model or “DAM generator” may be trained for nuisance filtering using design information as input training data and ground truth DOI and nuisance locations as output training data.

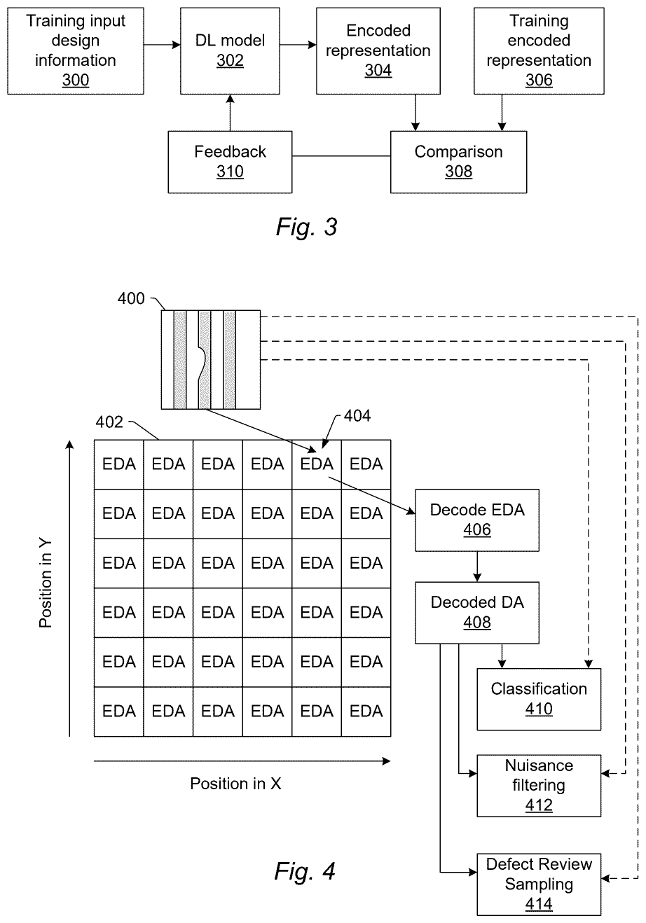

During training, as shown in FIG. 3, training input design information 300 is input to DL model 302, and the output generated for the input training data, e.g., encoded representation 304, may be compared to the output training data, e.g., training encoded representation 306, in comparison step 308. The differences between the inferred output and the output training data may then be used to make one or more changes to one or more parameters of the DL model, e.g., via feedback step 310, and the parameters that are altered may include any alterable parameters of the DL model. The changes may be made using a function like backpropagation or any other suitable feedback mechanism known in the art.

The training described above is perhaps the simplest manner in which training may be performed for the DL models described herein. In general, the DL models described herein may be trained using any suitable supervised learning approach. Once the DL model has been trained, design information for a specimen may be input to the DL model to thereby generate an encoded representation.

In another embodiment, the computer system is configured for training the DL model by supervised learning with labeled training data. For example, in some cases, the same computer system that is configured for generating the encoded representation, by inputting the design for the specimen into the DL model, and storing the encoded representation may also be configured for performing training of the DL model. The same computer system may also be configured for determining information for the specimen in the process. In this manner, one computer system may be configured for all of the steps described herein. However, different computer systems may be configured for performing two or more of the steps described herein. For example, one computer system may be configured for training the DL model and generating the encoded representation, and another computer system may be configured for using the encoded representation during a process to determine information for the specimen.

The computer system is configured for storing the encoded representation for use in a process performed on the specimen by a tool. The computer system may be configured for storing the encoded representation as described further herein. The encoded representation may have any suitable form or format, which may vary depending on which function it will be used for in a process.

The embodiments described herein may use the design during the process for some functions like image-to-design alignment. However, in some embodiments, the process includes determining information for the specimen based on the encoded representation in combination with output generated for the specimen by the tool during the process and without the information for the design or other information generated from the design. For example, the embodiments described herein do not actually use the IC physical design information during the processes in which information is determined for the specimen. In particular, the embodiments described herein do not need to extract design clips from a design for the specimen at positions of interest on the specimen found during the process (e.g., at positions of detected defects or positions at which measurements are performed). In addition, the embodiments described herein do not need to acquire the design for any other purpose such as determining information from the design that is used to determine information for positions of interest on the specimen. Instead, any design attributes that may be useful can be included in the encoded representation. Therefore, one or more design attributes for any position of interest on the specimen can be acquired from the encoded representation and used as described further herein.

In another embodiment, the process includes determining information for the specimen based on the encoded representation in combination with output generated for the specimen by the tool during the process, and determining the information for the specimen is performed during the process. For example, systems and methods like the inspection tools described herein may generate information for the specimen that is available for use in combination with the encoded representation for the functions described further herein. In one such example, an image generated for a defect detected on a specimen and the encoded representation may be used to classify the detected defect. The embodiments described herein may be configured to use any such images and/or other information determined by the tool or computer system in combination with the encoded representation to determine information for the specimen. In this manner, the encoded representation may be used as an additional set of novel attributes for determining information for the specimen.

In this and other embodiments described herein, determining information for the specimen during the process based on at least the encoded representation (in combination with output generated for the specimen by the tool during the process) generally means that the information is determined inline, on-tool, or as the tool generates output (e.g., images, measurements, etc.) during scanning of the specimen. For example, as an inspection tool detects defects on a specimen, rather than using the design itself for functions such as defect classification and nuisance filtering, a computer system of the inspection tool may find the encoded design attributes in the encoded design for the defect positions as described herein, decode the design attributes at the corresponding positions, and use the decoded design attributes for those functions. Since these processes are substantially faster than existing DBA computation methods requiring design clip extraction for every defect, which make DBAs computationally prohibitive for runtime, inline use, the embodiments enable inline use of DBAs. Runtime, inline processing is sometimes referred to as “on Leaf” processing, meaning that the processing is performed by a “Leaf” processor, node, or other image processing HW of the tool often used for functions like defect detection, e.g., in the case of “nuisance event filtering (NEF) on Leaf.” In general, though, any computer system that determines information for the specimen during the process may be configured to use the encoded representation as described herein during the process. In this manner, the embodiments described herein advantageously enable runtime nuisance filtering, defect classification, and other functions described herein since they are much faster than currently used methods and systems.

In one embodiment, the process includes determining information for the specimen by identifying positions in the encoded representation corresponding to positions on the specimen at which output is generated by the tool during the process, decoding the encoded design attributes at the identified positions, and determining information for the specimen based on the decoded design attributes. For example, the pixel(s) of the DAM that intersect a position of interest on the specimen may be identified. (The position of interest on the specimen may be any position at which output is generated by the tool during the process and that is of interest to a user for any reason such as that a defect candidate was detected at the position or a patterned feature of interest is located at the position.) In other words, this step may include intersecting the optical image of the specimen with data generated from design.

In the embodiment of a runtime phase shown in FIG. 4, for example, optical image 400 in which a defect in the middle feature in the image has been detected may be intersected with DAM 402 thereby identifying pixel 404 in the DAM that corresponds to the position on the specimen at which the optical image was generated. Determining the pixel(s) of the DAM that correspond to a position of interest on the specimen may include some kind of alignment step between the DAM and the output generated by the tool. Such alignment may include, for example, a runtime align-to-design method or “pixel to design alignment” (PDA). Any alignment method or system that can align a specimen image to design coordinates may be used in this step.

Then, the process may include decoding the DBAs for the DAM pixel(s) that intersect the position of interest on the specimen. For example, as shown in FIG. 4, for optical image 400, the EDA in pixel 404 of DAM 402 may be input to decode EDA step 406 thereby generating decoded design attribute (DA) 408. In particular, once the DAM and position of interest are intersected to identify the correct pixel, the attribute(s) in that pixel are decoded to get the design attribute(s) for the position of interest. The decoded attribute(s) can then be used for one or more of the functions described herein. In general, the decoding step may be performed using any suitable method such as a lookup function or a set of bit mask shift operations. In addition, given the DBA(s) for the position of interest, the process may include using the new DBA(s) just like any other design- or image-based attributes determined by the tool, the computer system, another system or method, etc. for determining information for the specimen, which may include, but is not limited to, defect classification 410, nuisance defect filtering 412, and other determinations described herein such as defect review sampling 414.

In one such embodiment, the information is determined based on the decoded design attributes in combination with the output generated by the tool during the process. For example, the process may include, given the DBA(s) for the position of interest, using the new DBA(s) in combination with any other image-based attributes determined by the tool, the computer system, another system or method, etc. for determining information for the specimen, which may include nuisance defect filtering, defect classification, and other determinations described herein.

As shown in FIG. 4, for example, decoded DA 408 may be input to one or more of defect classification 410, nuisance filtering 412, and other information determination steps like defect review sampling 414 in combination with specimen image 400. Each of these steps may determine one or more image-based attributes for the position of interest on the specimen, e.g., the defect detected in the image, which may then be used with the decoded DA for that function. Examples of such image-based attributes, include, but are not limited to, defect contrast, brightness, energy, grey level, size, shape, orientation, and the like. Such image-based attributes may be determined using any suitable method or algorithm known in the art. In addition, each of the steps shown in FIG. 4 may be configured to determine more than one image-based attribute that is used for that step.

Instead of the image-based attributes being determined in the defect classification, nuisance filtering, or other information determination steps, the image-based attributes may be determined in a separate step (not shown) and then input to the information determination steps. Such an attribute determination step may be performed by any computer system included in or coupled to the tool performing the process on the specimen. In this manner, the specimen images may or may not be input to the information determination steps shown in FIG. 4. For example, the image-based attributes may be input to defect classification 410, nuisance filtering 412, and other information determination steps like defect review sampling 414 instead of or in addition to specimen image 400.

In another embodiment, the process includes detecting defects on the specimen and filtering nuisances from the defects by identifying positions in the encoded representation corresponding to positions of the defects, decoding the encoded design attributes at the identified positions, identifying the nuisances based on the decoded design attributes, and removing the nuisances from results for the defects. The computer system or another system or method may be configured for performing defect detection using any suitable defect detection method or algorithm. For instance, an inspection tool may be configured for generating test images of a specimen during an inspection process. The computer system may subtract a reference image from a test image to thereby generate a difference image. Detecting the defects may also include applying some threshold to the difference image, and that threshold may be commonly referred to in the art as a defect detection threshold. The threshold that is used for defect detection may be determined as described herein (e.g., based on segmentation information for the design on the specimen). Any image signals or data in the difference image having a value above the threshold may be identified by the computer system as a defect or potential defect. All other image signals or data in the difference image may not be identified as a defect or potential defect.

Of course, this is perhaps the most simple version of how defect detection can be performed using results of subtracting a reference image from a test image. The embodiments described herein are not limited in the defect detection method or algorithm performed in the process in which the encoded representation is used. For example, once a reference image has been subtracted from a test image, there are many different defect detection methods or algorithms that can be used to detect defects or potential defects in the resulting difference image. Any or all such defect detection methods or algorithms can be used in the embodiments described herein, and an appropriate method or algorithm can be selected based on information about the specimen.

In this embodiment, identifying the positions in the encoded representation corresponding to the positions of the defects and decoding the encoded design attributes at the identified positions may be performed as described further herein.

Identifying the nuisances based on the decoded design attributes may include inputting at least decoded DA 408 into nuisance filtering step 412 as shown in FIG. 4. The nuisance filtering may then be performed using any suitable nuisance filtering method or system known in the art that is or can be configured to filter defects based on DBAs. In one such example, the nuisance filtering may include identifying any defects that are detected on a particular patterned structure in the design for the specimen as nuisances, and which patterned structure that defects are detected on may be determined from the decoded design attributes. In other words, nuisance filtering may include determining if a defect is located on a particular patterned structure in the design based on the decoded attributes and then identifying any of the defects so located as nuisances. Nuisance filtering may be performed based on any other DBAs in a similar manner.

In one such embodiment, identifying the nuisances is performed based on the decoded design attributes in combination with one or more defect attributes determined from output generated by the tool during the process. For example, in the nuisance filtering described above, an image-based attribute like defect size may also be input to this nuisance filtering step, and any defects detected on such a patterned structure and having a size outside of a given size range may be identified as nuisances and removed from the inspection results as described herein. Any other image-based attributes may be used with the decoded design attributes for nuisance filtering. In addition, the image-based attributes and the decoded design attributes may be input to nuisance filtering in the same manner as any other image-based attributes and DBAs.

In any of these embodiments, removing the nuisances from results for the defects may be performed in any suitable manner. For instance, if the nuisances are being identified during runtime, which is one of the advantageous uses of the embodiments described herein since they are particularly suitable for substantially high detection rates, then any identified nuisances may simply not be reported or included in the inspection results. If the nuisances are being identified after generation of some inspection results, the defects that are identified as nuisances may be eliminated from the inspection results or discarded. In this manner, the nuisances may be eliminated from already generated inspection results or may otherwise be removed from inspection results before they are stored, exported, etc. and available for other uses.

In an additional embodiment, the process includes detecting defects on the specimen and classifying the defects by identifying positions in the encoded representation corresponding to positions of the defects, decoding the encoded design attributes at the identified positions, and classifying the defects based on the decoded design attributes. Detecting the defects on the specimen, identifying the positions in the encoded representation corresponding to the positions of the defects, and decoding the encoded design attributes may be performed as described further herein. Classifying the defects based on the decoded design attributes may include simply inputting the decoded design attributes into a defect classification method or algorithm. For example, the decoded design attributes may be input to and used by a defect classification method or algorithm in the same manner as any other design attributes. Classifying the defects may be further performed as described herein.

In some such embodiments, classifying the defects is performed based on the decoded design attributes in combination with one or more defect attributes determined from output generated by the tool during the process. For example, some currently used inspection tools utilize multiple defect attributes (and sometimes many defect attributes) for defect classification performed inline with inspection. In one such example, the peak difference signal of a defect is a defect image attribute that may be used to classify candidate defects inline with inspection. The DAM may then provide an additional set of novel attributes for defect classification. The decoded design attributes and the image-based attributes may be input to the defect classification method or algorithm in any suitable manner.

In this manner, the process in which the encoded representation is used to determine information for a specimen (e.g., which may be performed by a defect detection module of an inspection tool) may include determining the pixel(s) of the DAM that intersect the candidate defect. The process may then include decoding the DBA(s) for the DAM pixel(s) that intersect the candidate defect. Then, given the DBA(s) for the candidate defect, the process may include utilizing the new DBA(s) just like any other (usually image-based) attributes that are currently used for nuisance defect filtering, defect classification, etc.

In a further embodiment, the process includes detecting defects on the specimen at a rate of more than 100,000 defects per second and determining information for each of the detected defects based on the encoded representation and output generated for the defects by the tool during the process, and determining the information for each of the detected defects is performed during the process. For example, the embodiments described herein enable the use of IC physical design information for substantially high bandwidth nuisance defect filtering and DOI classification. Such substantially high bandwidth information determination is an important feature and advantage of the embodiments described herein because it enables the use of DBAs for nuisance defect filtering and other functions described herein at runtime. In many advanced inspection tools, for example, the defect detection rate at runtime is substantially high, e.g., about 300 million defects for a 30 minute inspection or about 150,000 defects per second. Detecting the defects and determining the information may be performed in this embodiment as described further herein.

In one such embodiment, determining the information for each of the detected defects during the process is performed by a computer system included in the tool. For example, determining information for a specimen as described herein may be performed by a defect detection, nuisance defect filtering, and/or defect classification module of an inspection tool. In one such example, determining the information during the process may be performed by computer system 36 included in tool 10 shown in FIG. 1 or computer system 124 included in the tool shown in FIG. 2. In this manner, one or more of the functions described herein such as nuisance filtering, defect classification, etc. may be performed during the process on-tool (i.e., by a computer system of the tool as the specimen is being scanned to thereby generate images and/or other output for the specimen).

In one embodiment, the tool includes a light-based inspection tool. In another embodiment, the tool includes an electron beam-based inspection tool. For example, as described herein, one of the most advantageous uses of the embodiments described herein is for nuisance filtering and defect classification during an inspection process including particularly high bandwidth (i.e., number of defects detected per second) inspection processes. In this manner, the encoded representation may be stored for use by a light- or electron beam-based inspection tool, both of which may be configured as described further herein and shown in FIGS. 1 and 2, respectively.

In an additional embodiment, the tool includes a defect review tool. For example, the encoded representation may have uses for defect review. In one such implementation, the encoded representation may be used as described herein to determine DBAs of defects detected on a specimen. Generally, the number of detected defects is large enough that not all defects can be reviewed in a time or cost efficient manner. Therefore, a sample of the defects is usually selected from the total population of detected defects (often referred to as “sampling”), the sample, then much smaller in number than the total population, is reviewed, and the results of the defect review are used to determine information for the whole population.

In this manner, the defects that are included in the sample can be quite important, e.g., so they are representative of the entire population, the DOIs, both DOIs and nuisances, etc. In one such example, defects located at as many different positions in the design may be selected to generate a representative sample of the entire population. In another such example, defects located on a subset of design-relative positions may be selected to gain some understanding of the defects present at one or more positions of interest. In this manner, the encoded representation may be used as described herein to determine decoded design attributes for some or all of the defects detected on a specimen. The defects may then be selected for review based at least in part on the decoded design attributes (possibly in combination with other information described herein such as image-based attributes of the detected defects).

The embodiments described herein have a number of advantages in addition to those already described. For example, unlike the embodiments described herein, some currently used methods and systems for nuisance defect filtering and defect classification do not use IC physical design information at all. In this context, one significant advantage and improvement of the embodiments described herein over such methods and systems is that they provide dramatically improved nuisance defect filtering and defect classification. In another example, some currently used methods and systems for nuisance defect filtering and defect classification do use IC physical design information. In this context, a significant advantage and improvement of the embodiments described herein over such methods and systems is that they provide a significant cost savings. In particular, a rough cost estimate to utilize design-based attributes using the currently used methods is about $50,000 per tool for additional compute and storage capability. Furthermore, the embodiments described herein enable the indirect use of IC physical design information for nuisance defect filtering and defect classification, which can significantly improve inspection sensitivity.

As described above, the computer system is configured for storing the encoded representation of the design for use in a process performed on the specimen by a tool. The computer system may be configured to store the encoded representation in a recipe or by generating a recipe for the process in which the encoded representation will be used. A “recipe” as that term is used herein is defined as a set of instructions that can be used by a tool to perform a process on a specimen. In this manner, generating a recipe may include generating information for how a process is to be performed, which can then be used to generate the instructions for performing that process. The information for the encoded representation that is stored by the computer system may include any information that can be used to identify, access, and/or use the encoded representation (e.g., such as a file name and where it is stored). The information for the encoded representation that is stored may also include the actual encoded representation, possibly with any instructions, algorithms, etc. for using the encoded representation for one or more functions described herein.

The computer system may also be configured for storing the encoded representation in any suitable computer-readable storage medium. The encoded representation and/or any of the results described herein may be stored in any manner known in the art. The storage medium may include any storage medium described herein or any other suitable storage medium known in the art. After the encoded representation has been stored, the encoded representation can be accessed in the storage medium and used by any of the method or system embodiments described herein, formatted for display to a user, used by another software module, method, or tool, etc. Other results described herein can be stored and used in the same manner. For example, the embodiments described herein may generate defect classification results, nuisance filtering results, etc. as described above. Those results may then be stored and used by the system or method (or another tool or method) as described further herein.

Results and information generated by performing a process on the specimen or other specimens of the same type with the encoded representation may be used in a variety of manners by the embodiments described herein and/or other systems and methods. Such functions include, but are not limited to, altering a process such as a fabrication process or step that was or will be performed on the specimen or another specimen in a feedback or feedforward manner. For example, the computer system described herein may be configured to determine one or more changes to a process that was performed on a specimen inspected as described herein and/or a process that will be performed on the specimen based on the classified and/or nuisance filtered defect(s). The changes to the process may include any suitable changes to one or more parameters of the process. The computer system preferably determines those changes such that the defects can be reduced or prevented on other specimens on which the revised process is performed, the defects can be corrected or eliminated on the specimen in another process performed on the specimen, the defects can be compensated for in another process performed on the specimen, etc. The computer system described herein may determine such changes in any suitable manner known in the art.

Those changes can then be sent to a semiconductor fabrication system (not shown) or a storage medium (not shown) accessible to the computer system described herein and the semiconductor fabrication system. The semiconductor fabrication system may or may not be part of the system embodiments described herein. For example, the system described herein may be coupled to the semiconductor fabrication system, e.g., via one or more common elements such as a housing, a power supply, a specimen handling device or mechanism, etc. The semiconductor fabrication system may include any semiconductor fabrication system known in the art such as a lithography tool, an etch tool, a chemical-mechanical polishing (CMP) tool, a deposition tool, and the like.

As described herein, therefore, the embodiments can be used to setup a new process or recipe. The embodiments may also be used to modify an existing process or recipe, whether that is a process or recipe that was used for the specimen or was created for one specimen and is being adapted for another specimen. In addition, the embodiments described herein are not just limited to encoded representation creation or modification. For example, the embodiments described herein may be configured to select one or more other parameters for inspection, defect review, metrology, etc. such as output processing parameters as a function of position within the design. In one such example, the computer system may be configured to determine parameters of the defect classification to be used as a function of position with the design. Those defect classification parameters may be determined in any suitable manner, and the defect classification parameters may be stored with the encoded representation as a function of position within the design.

As described above, the system is configured for generating the encoded representation of the design for the specimen and storing it for use by a tool. A system configured for determining information for a specimen may, however, be configured for only using the encoded representation. For example, one system may be configured for generating the encoded representation and storing it for use, and a different system may be configured only for using the encoded representation to determine information for a specimen. The encoded representation may also be used to determine information for more than one specimen on which devices of the same design are being formed (at the same layer in the design).

One such embodiment includes a computer system configured for identifying positions in an encoded representation of a design for a specimen corresponding to positions on the specimen at which output is generated by a tool during a process performed on the specimen by the tool, which may be performed as described further herein. The encoded representation may be generated as described herein by a DL model configured as described herein for transforming information for the design for the specimen into the encoded representation. The encoded representation includes encoded design attributes as a function of position in the design and may be further configured as described herein.

The computer system in this embodiment is also configured for decoding the encoded design attributes at the identified positions and determining information for the specimen based on the decoded design attributes, both of which may be configured as described herein.

This embodiment of the system may be further configured as described herein. For example, in one embodiment, the information is determined based on the decoded design attributes in combination with the output generated by the tool during the process. In another embodiment, the process includes detecting defects on the specimen based on the output generated by the tool, and determining the information includes filtering nuisances from the defects by identifying the nuisances based on the decoded design attributes and removing the nuisances from results for the defects. In one such embodiment, identifying the nuisances is performed based on the decoded design attributes in combination with one or more defect attributes determined from the output generated by the tool during the process.

In a further embodiment, the process includes detecting defects on the specimen based on the output generated by the tool, and determining the information includes classifying the defects based on the decoded design attributes. In some such embodiments, classifying the defects is performed based on the decoded design attributes in combination with one or more defect attributes determined from the output generated by the tool during the process.

In an additional embodiment, determining the information is performed based on the decoded design attributes in combination with the output generated for the specimen by the tool during the process and without the information for the design or other information generated from the design. In another embodiment, determining the information is performed based on the decoded design attributes in combination with the output generated for the specimen by the tool during the process, and determining the information for the specimen is performed during the process.

In some embodiments, the process includes detecting defects on the specimen at a rate of more than 100,000 defects per second, determining the information includes determining information for each of the detected defects based on the decoded design attributes and output generated for the defects by the tool during the process, and determining the information for each of the detected defects is performed during the process. In one such embodiment, determining the information for each of the detected defects during the process is performed by the computer system or an additional computer system included in the tool.

In one embodiment, the encoded representation is configured as a design attribute map that includes the encoded design attributes as the function of the position in the design. In another embodiment, the encoded representation is configured as a raster image for at least a portion of an entire device in the design, and each pixel in the raster image includes the encoded design attributes at the position in the design corresponding to each pixel.

In some embodiments, the DL model is configured for learning how to perform the transforming by supervised learning. In another embodiment, the tool includes a light-based inspection tool. In an additional embodiment, the tool includes an electron beam-based inspection tool. In a further embodiment, the tool includes a defect review tool.

Each of these embodiments of the system may be further configured as described herein.

Each of the embodiments of each of the systems described above may be combined together into one single embodiment.

Another embodiment relates to a computer-implemented method for determining information for a specimen. The method includes transforming information for a design for a specimen into an encoded representation of the design that includes encoded design attributes as a function of position in the design. The transforming is performed by a DL model included in one or more components executed by a computer system, which may be configured according to any of the embodiments described herein. The method also includes storing the encoded representation for use in a process performed on the specimen by a tool, and storing the encoded representation is performed by the computer system.

Yet another embodiment relates to a computer-implemented method for determining information for a specimen. The method includes identifying positions in an encoded representation of a design for a specimen corresponding to positions on the specimen at which output is generated by a tool during a process performed on the specimen by the tool. The encoded representation is generated by a DL model configured for transforming information for the design for the specimen into the encoded representation, and the encoded representation includes encoded design attributes as a function of position in the design. The method also includes decoding the encoded design attributes at the identified positions and determining information for the specimen based on the decoded design attributes.

Each of the steps of each of the methods may be performed as described further herein. Each of the methods may also include any other step(s) that can be performed by the DL model, computer system, tool, and/or system described herein. In addition, each of the methods described above may be performed by any of the system embodiments described herein.

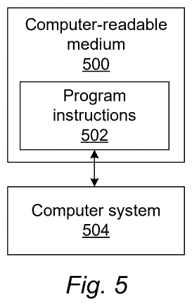

An additional embodiment relates to a non-transitory computer-readable medium storing program instructions executable on a computer system for performing a computer-implemented method for determining information for a specimen. One such embodiment is shown in FIG. 5. In particular, as shown in FIG. 5, non-transitory computer-readable medium 500 includes program instructions 502 executable on computer system 504. The computer-implemented method may include any step(s) of any method(s) described herein.

Program instructions 502 implementing methods such as those described herein may be stored on computer-readable medium 500. The computer-readable medium may be a storage medium such as a magnetic or optical disk, a magnetic tape, or any other suitable non-transitory computer-readable medium known in the art.

The program instructions may be implemented in any of various ways, including procedure-based techniques, component-based techniques, and/or object-oriented techniques, among others. For example, the program instructions may be implemented using ActiveX controls, C++ objects, JavaBeans, Microsoft Foundation Classes (“MFC”), SSE (Streaming SIMD Extension) or other technologies or methodologies, as desired.

Computer system 504 may be configured according to any of the embodiments described herein.

Further modifications and alternative embodiments of various aspects of the invention will be apparent to those skilled in the art in view of this description. For example, methods and systems for determining information for a specimen are provided. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

1. A system configured for determining information for a specimen, comprising:
a computer system: and
one or more components executed by the computer system, wherein the one or more components comprise a deep learning model configured for transforming information for a design for a specimen input to the deep learning model by the computer system into an encoded representation of the design comprising encoded design attributes as a function of position in the design; and
wherein the computer system is configured for storing the encoded representation for use in a process performed on the specimen by a tool.

2. The system of claim 1, wherein the process comprises determining information for the specimen by identifying positions in the encoded representation corresponding to positions on the specimen at which output is generated by the tool during the process, decoding the encoded design attributes at the identified positions, and determining information for the specimen based on the decoded design attributes.

3. The system of claim 2, wherein the information is determined based on the decoded design attributes in combination with the output generated by the tool during the process.

4. The system of claim 1, wherein the process comprises detecting defects on the specimen and filtering nuisances from the defects by identifying positions in the encoded representation corresponding to positions of the defects, decoding the encoded design attributes at the identified positions, identifying the nuisances based on the decoded design attributes, and removing the nuisances from results for the defects.

5. The system of claim 4, wherein identifying the nuisances is further performed based on the decoded design attributes in combination with one or more defect attributes determined from output generated by the tool during the process.

6. The system of claim 1, wherein the process comprises detecting defects on the specimen and classifying the defects by identifying positions in the encoded representation corresponding to positions of the defects, decoding the encoded design attributes at the identified positions, and classifying the defects based on the decoded design attributes.

7. The system of claim 6, wherein classifying the defects is further performed based on the decoded design attributes in combination with one or more defect attributes determined from output generated by the tool during the process.

8. The system of claim 1, wherein the process comprises determining information for the specimen based on the encoded representation in combination with output generated for the specimen by the tool during the process and without the information for the design or other information generated from the design.

9. The system of claim 1, wherein the process comprises determining information for the specimen based on the encoded representation in combination with output generated for the specimen by the tool during the process, and wherein determining the information for the specimen is performed during the process.

10. The system of claim 1, wherein the process comprises detecting defects on the specimen at a rate of more than 100,000 defects per second and determining information for each of the detected defects based on the encoded representation and output generated for the defects by the tool during the process, and wherein determining the information for said each of the detected defects is performed during the process.

11. The system of claim 10, wherein determining the information for said each of the detected defects during the process is further performed by a computer system included in the tool.

12. The system of claim 1, wherein the encoded representation is configured as a design attribute map comprising the encoded design attributes as the function of the position in the design.

13. The system of claim 1, wherein the encoded representation is configured as a raster image for at least a portion of an entire device in the design, and wherein each pixel in the raster image comprises the encoded design attributes at the position in the design corresponding to said each pixel.

14. The system of claim 1, wherein the deep learning model is further configured for learning how to perform said transforming by supervised learning.

15. The system of claim 1, wherein the computer system is further configured for training the deep learning model by supervised learning with labeled training data.

16. The system of claim 1, wherein the tool comprises a light-based inspection tool.

17. The system of claim 1, wherein the tool comprises an electron beam-based inspection tool.

18. The system of claim 1, wherein the tool comprises a defect review tool.

19. A non-transitory computer-readable medium, storing program instructions executable on a computer system for performing a computer-implemented method for determining information for a specimen, wherein the computer-implemented method comprises:
transforming information for a design for a specimen into an encoded representation of the design comprising encoded design attributes as a function of position in the design, wherein the transforming is performed by a deep learning model included in one or more components executed by the computer system; and
storing the encoded representation for use in a process performed on the specimen by a tool.

20. A computer-implemented method for determining information for a specimen, comprising:
transforming information for a design for a specimen into an encoded representation of the design comprising encoded design attributes as a function of position in the design, wherein the transforming is performed by a deep learning model included in one or more components executed by a computer system; and
storing the encoded representation for use in a process performed on the specimen by a tool, wherein said storing is performed by the computer system.

21. A system configured for determining information for a specimen, comprising:
a computer system configured for:
identifying positions in an encoded representation of a design for a specimen corresponding to positions on the specimen at which output is generated by a tool during a process performed on the specimen by the tool, wherein the encoded representation is generated by a deep learning model configured for transforming information for the design for the specimen into the encoded representation, and wherein the encoded representation comprises encoded design attributes as a function of position in the design;
decoding the encoded design attributes at the identified positions; and
determining information for the specimen based on the decoded design attributes.

22.-36. (canceled)
